(19) United States
(12) Patent Application Publication
(10) Pub. No.: US 2009/0007709 A1
(43) Pub. Date: Jan. 8, 2009

(54) Automatic transmission

(75) Inventors: Kazuhiko Sugita, Brussels (BE); Naoji Katou, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 12/216,501

(22) Filed: Jul. 7, 2008

(30) Foreign Application Priority Data
Jul. 6, 2007 (JP) 2007-178426

(51) Int. Cl. F16H 57/10; F16D 65/092; F16D 55/40

(52) U.S. Cl. 74/411.5; 188/71.1; 188/264 P

(57) ABSTRACT

A brake system that includes a friction plate composed of inner friction plates and outer friction plates that are arranged alternately in an axial direction; a cylinder portion that is open toward the friction plate in the axial direction; a piston member that slidably fits into an opening portion of the cylinder portion, thereby forming a working oil chamber, and that is pressed and driven away from the cylinder portion in the axial direction by oil pressure supplied to the working oil chamber, thereby pressing the friction plate; a return spring that biases the piston member toward the cylinder portion in the axial direction; and a drum member integrally provided with a drum portion that is in spline engagement with the friction plate, a pressure-receiving portion that is formed in a vertical direction to the axial direction and receives a reaction force of the return spring, and a fixed portion.

### CROSS-REFERENCE TO RELATED APPLICATION

The disclosure of Japanese Patent Application No. 2007-178426 filed on Jul. 6, 2007, including the specification, drawings and abstract, is incorporated herein by reference in its entirety.

### BACKGROUND

The present invention relates to an automatic transmission.

There exists an automatic transmission that is used for, for example, an FF-type (a front engine and a front drive) vehicle. A transmission mechanism is arranged on an input shaft, a counter shaft is arranged parallel to the input shaft, and the transmission mechanism and the counter shaft are adapted to be adjacent to each other.

In such an automatic transmission, the case that contains the transmission mechanism and the counter shaft cannot partition the transmission mechanism and the counter shaft because the output rotation from the transmission mechanism is transmitted to the counter shaft via gears, and the case is provided with a hole that allows a transmission mechanism portion and a counter shaft portion to communicate with each other.

Further, the lubricating oil diffused by the centrifugal force from a rotary shaft flows down along the inner surface of the case, and is recovered to a portion where the lubricating oil is made to stay, and a hole that allows the transmission mechanism portion and the counter shaft portion in the case to communicate with each other is large, so that the diffused lubricating oil can be smoothly recovered and the circulation of the lubricating oil can be stabilized.

However, in a case where a multi-disc-type brake system is provided on the transmission mechanism in the above automatic transmission, the entire periphery of the transmission mechanism in a position where the hole of the case is provided cannot be surrounded by the case. Therefore, even when the spline is formed at the inner peripheral surface of the case in order to make a friction plate engaged by, for example, a spline, etc., the spline cannot be formed, and is partially missing. In this state, in the portion where the spline cannot be formed, a reaction force cannot be received even if a snap ring for regulating the axial movement of the friction plate is arranged. Therefore, there is a fear that the balance of the pressing force of the friction plate is deteriorated, and the controllability of the automatic transmission is affected. For this reason, in the above brake system, a drum member fixed to the case is provided, the inner peripheral surface of the drum member is formed with a spline where the friction plate is arranged, and a reaction force is received by the snap ring. As a result, the balance of the pressing force of the friction plate can be made equal, and the controllability of the automatic transmission is good (for example, refer to JP-A-2002-349683).

### SUMMARY

Meanwhile, the multi-disc-type brake system is configured such that the piston member presses the friction plate so as to bring a rotating element into a locked state. In order to bring such a brake system into a released state, it is necessary to dispose a return spring biased in a direction in which the piston member is separated from the friction plate.

However, in the automatic transmission of the above JP-A-2002-349683, in order to dispose the return spring, a washer and a supporting plate that receive the load of the return spring are arranged at a front end of the drum member of the brake system, and the washer is fixed to the piston member that presses the friction plate with the snap ring, and the return spring is provided in a compressed manner between the piston member and the friction member. As a result, the configuration becomes complicated, and an increase in the number of parts and complicatedness of the manufacturing process are caused.

Further, the brake system provided with the drum member as described above can be made the same configuration as a general clutch system. However, for that purpose, it is necessary to provide a return plate that receives the reaction force of the return spring. Particularly, since the brake system is arranged on the outer peripheral side of the transmission mechanism, it is difficult to fix the return plate to an input shaft, etc. Thus, it is necessary to fix the return plate to the inner peripheral surface of the case, the inner peripheral surface of the drum member, etc., by a snap ring, welding, etc. As a result, the configuration becomes complicated, and an increase in the number of parts and complicatedness of the manufacturing process are caused.

Thus, the invention provides an automatic transmission capable of arranging a return spring, in a brake system in which a drum member is to be disposed, by a simple configuration, and achieving a reduction in the number of parts, and simplification of a manufacturing process. The invention can also achieve various other advantages.

The invention, according to an exemplary aspect, includes an automatic transmission with a transmission mechanism; a case; and a brake system that enables a rotation of a rotating element of the transmission mechanism disposed on an axis to be fixed with respect to the case. The brake system includes: a friction plate composed of inner friction plates and outer friction plates that are arranged alternately in an axial direction; a cylinder portion that is open toward the friction plate in the axial direction; a piston member that slidably fits into an opening portion of the cylinder portion, thereby forming a working oil chamber, and that is pressed and driven away from the cylinder portion in the axial direction by oil pressure supplied to the working oil chamber, thereby pressing the friction plate; a return spring that biases the piston member toward the cylinder portion in the axial direction; and a drum member integrally provided with a drum portion that is in spline engagement with the friction plate, a pressure-receiving portion that is formed in a vertical direction to the axial direction and receives a reaction force of the return spring, and a fixed portion fixed to the case.

The invention, according to an exemplary aspect, includes a brake system with a friction plate composed of inner friction plates and outer friction plates that are arranged alternately in an axial direction; a cylinder portion that is open toward the friction plate in the axial direction; a piston member that slidably fits into an opening portion of the cylinder portion, thereby forming a working oil chamber, and that is pressed and driven away from the cylinder portion in the axial direction by oil pressure supplied to the working oil chamber, thereby pressing the friction plate; a return spring that biases the piston member toward the cylinder portion in the axial direction; and a drum member integrally provided with a drum portion that is in spline engagement with the friction plate, a pressure-receiving portion that is formed in a vertical direction to the axial direction and receives a reaction force of the return spring, and a fixed portion.

### BRIEF DESCRIPTION OF THE DRAWINGS

Various exemplary aspects of the invention will be described with reference to the drawings, wherein:

FIG. 1 is a sectional side view showing a brake according to an embodiment;

FIG. 2 is a skeleton view showing an automatic transmission;

FIG. 3 is an operation table of the automatic transmission;

FIG. 4 is a speed diagram of the automatic transmission; and

FIG. 5 is a rear view showing a pump body and a pump cover according to the embodiment.

### DETAILED DESCRIPTION OF EMBODIMENTS

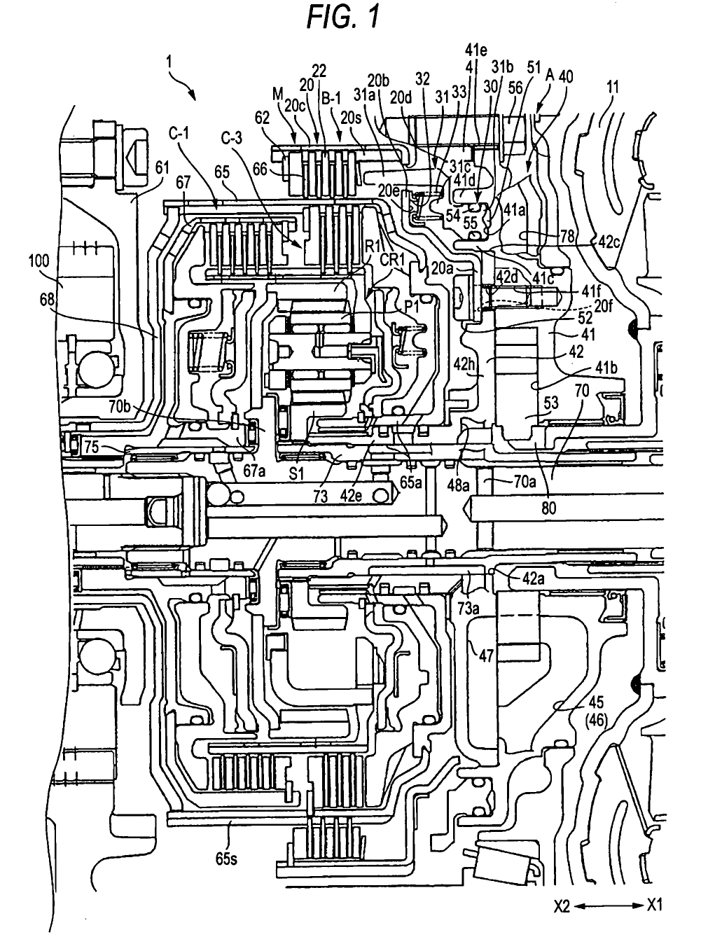

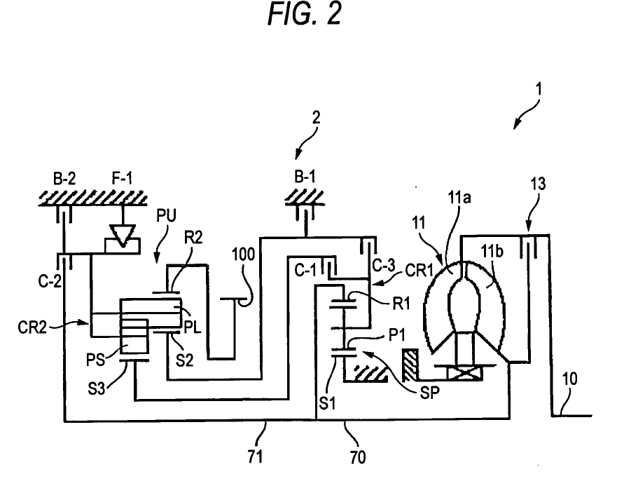

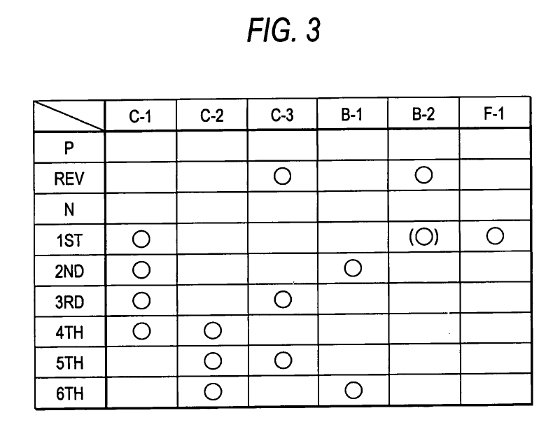

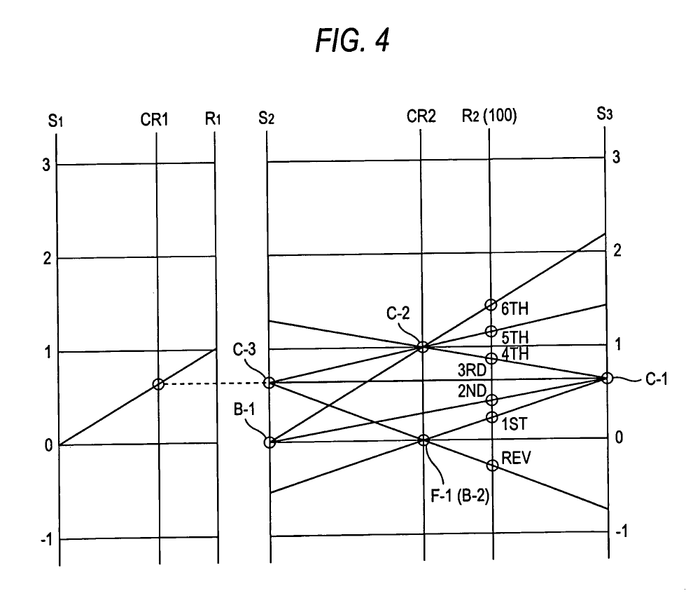

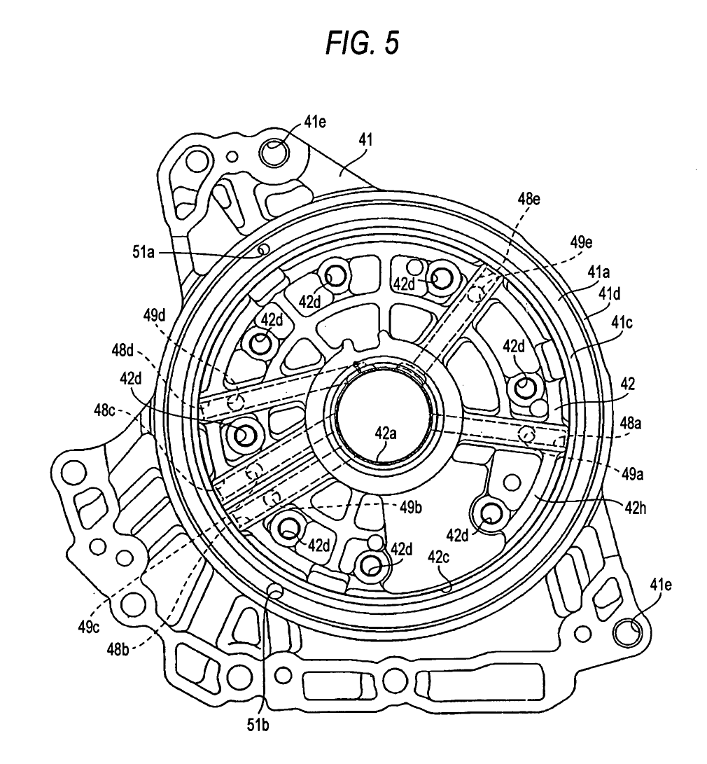

Hereinafter, a first embodiment according to the invention will be explained with reference to FIGS. 1 to 5. FIG. 1 is a sectional side view showing a brake B-1 according to this embodiment, FIG. 2 is a skeleton view showing an automatic transmission 1, FIG. 3 is an operation table of the automatic transmission, FIG. 4 is a speed diagram of the automatic transmission 1, and FIG. 5 is a rear view showing a pump body and a pump cover according to this embodiment. In addition, when the automatic transmission 1 according to this embodiment is mounted on a vehicle, its axial direction becomes a horizontal direction. However, in the present specification, the automatic transmission 1 as seen from the side to which an engine is connected, i.e., from the torque converter 11 side, is defined as the front. FIG. 1 is a sectional side view as seen from the side, and FIG. 5 is a rear view as seen from the rear.

First, the schematic configuration of an automatic transmission 1 to which the invention can be applied will be explained with reference to FIG. 2. As shown in FIG. 2, an automatic transmission 1 suitable for an FF-type (a front engine and a front drive) vehicle has an input shaft 10 that can be connected to an engine that is not shown, and includes a torque converter 11 and a transmission mechanism 2 around the axial direction of the input shaft 10.

The torque converter 11 has a pump impeller 11a connected to the input shaft 10 of the automatic transmission 1, and a turbine runner 11b to which the rotation of the pump impeller 11a is transmitted via a working fluid. The turbine runner 11b is connected to an input shaft 70 of the transmission mechanism 2 that is disposed coaxially with the input shaft 10. Further, the torque converter 11 includes a lock-up clutch 13, and when the lock-up clutch 13 is engaged by the oil pressure control of a hydraulic controller that is not shown, the rotation of the input shaft 10 of the automatic transmission 1 is directly transmitted to the input shaft 70 of the transmission mechanism 2.

In the transmission mechanism 2, a planetary gear SP and a planetary gear unit PU are provided on the input shaft 70. The planetary gear SP includes a sun gear S1, a carrier CR1, and a ring gear R1, and is a so-called single pinion planetary gear in which a pinion P1 that meshes with a sun gear S1 and a ring gear R1 is provided in the carrier CR1.

Further, the planetary gear unit PU has a sun gear S2, a sun gear S3, a carrier CR2, and a ring gear R2 that serve as four rotating elements, and is a so-called Ravigneaux-type planetary gear in which a long pinion PL that meshes with the sun gear S2 and the ring gear R2, and a short pinion PS that meshes with the sun gear S3 are provided in the carrier CR2 so as to mesh with each other.

The sun gear S1 of the planetary gear SP is connected to a boss (not shown) integrally fixed to a transmission case (case) 4 (refer to FIG. 1), and thereby, its rotation is fixed. Further, the ring gear R1 has the same rotation (hereinafter referred to as “input rotation”) as the rotation of the input shaft (rotary shaft) 70. Furthermore, the carrier CR1 has the deceleration rotation in which the speed of the input rotation is reduced by the fixed sun gear S1, and the ring gear R1 having the input rotation, and is connected to the clutch C-1 and the clutch C-3.

The sun gear S2 of the planetary gear unit PU is connected to the brake B-1, and is capable of being fixed to the transmission case 4, and is connected to the clutch C-3, allowing the deceleration rotation of the carrier CR1 to be input thereto via the clutch C-3. Further, the sun gear S3 is connected to the clutch C-1, allowing the deceleration rotation of the carrier CR1 to be input thereto.

Furthermore, the carrier CR2 is connected to the clutch C-2 to which the rotation of the input shaft 70 is input via an intermediate shaft 71, allowing the input rotation to be input thereto via the clutch C-2, and is connected to one-way clutch F-1 and a brake B-2, regulating the rotation thereof in one direction with respect to the transmission case 4 via the one-way clutch F-1, and allowing the rotation thereof to be fixed via the brake B-2. Also, the ring gear R2 is connected to an output gear 100 that outputs its rotation to a driving wheel that is not shown.

Subsequently, the operation of the transmission mechanism 2 will be explained with reference to FIGS. 2, 3, and 4 on the basis of the configuration. In addition, in the speed diagram shown in FIG. 4, the axis of ordinate shows the rotational frequency of respective rotating elements (respective gears), and the axis of abscissa shows the corresponding gear ratios of the rotating elements. Further, in the portions of the planetary gear SP of the speed diagram, the axis of ordinate at a horizontal endmost portion (the left in FIG. 4) corresponds to the sun gear S1, and in order rightward in the figure after the endmost portion, the axes of ordinate correspond to the carrier CR1 and the ring gear R1. Furthermore, in the portions of the planetary gear unit PU of the speed diagram, the axis of ordinate at a horizontal endmost portion (the right in FIG. 4) corresponds to the sun gear S3, and in order leftward in the figure after the endmost portion, the axes of ordinate correspond to the ring gear R2, the carrier CR2, and the sun gear S2.

For example, at a forward first speed stage (1ST) within the D (drive) range, as shown in FIG. 3, the clutch C-1 and one-way clutch F-1 are engaged. Then, as shown in FIGS. 2 and 4, the rotation of the carrier CR1 that is rotated at a reduced speed by the fixed sun gear S1, and the ring gear R1 that has input rotation, is input to the sun gear S3 via the clutch C-1. Further, the rotation of the carrier CR2 is regulated in one direction (normal rotation direction), that is, the reverse rotation of the carrier CR2 is prevented and is fixed. Then, the deceleration rotation input to the sun gear S3 is output to the ring gear R2 via the fixed carrier CR2, and the normal rotation as the forward first shift stage is output from the output gear 100.

In addition, at the time of engine brake (at the time of coasting), the brake B-2 is locked to fix the carrier CR2, and the state of the forward first shift stage is maintained in such a form that the normal rotation of the carrier CR2 is prevented. Further, at the forward first shift stage, the reverse rotation of the carrier CR2 is prevented, and the normal rotation thereof is enabled, by the one-way clutch F-1. Thus, the forward first shift stage when switching is made from a non-traveling range to a traveling range can be smoothly achieved, for example, by the automatic engagement of the one-way clutch F-1.

At a forward second shift stage (2ND), as shown in FIG. 3, the clutch C-1 is engaged, and the brake B-1 is locked. Then, as shown in FIGS. 2 and 4, the rotation of the carrier CR1 that is rotated at a reduced speed by the fixed sun gear S1, and the ring gear R1 that has input rotation, is input to the sun gear S3 via the clutch C-1. Further, the rotation of the sun gear S2 is fixed by the locking of the brake B-1. Then, the carrier CR2 has deceleration rotation that is slower than the rotation of the sun gear S3, the deceleration rotation input to the sun gear S3 is output to the ring gear R2 via the carrier CR2, and the normal rotation as the forward second shift stage is output from the output gear 100.

At a forward third shift stage (3TH), as shown in FIG. 3, the clutch C-1 and the clutch C-3 are engaged. Then, as shown in FIGS. 2 and 4, the rotation of the carrier CR1 that is rotated at a reduced speed by the fixed sun gear S1, and the ring gear R1 that has input rotation, is input to the sun gear S3 via the clutch C-1. Further, the deceleration rotation of the carrier CR1 is input to the sun gear S2 by the engagement of the clutch C-3. That is, since the deceleration rotation of the carrier CR1 is input to the sun gear S2 and the sun gear S3, the planetary gear unit PU is brought into a direct coupling state of deceleration rotation, the deceleration rotation is output to the ring gear R2 as it is, and the normal rotation as the forward third shift stage is output from the output gear 100.

At a forward fourth shift stage (4TH), as shown in FIG. 3, the clutch C-1 and the clutch C-2 are engaged. Then, as shown in FIGS. 2 and 4, the rotation of the carrier CR1 that is rotated at a reduced speed by the fixed sun gear S1, and the ring gear R1 that has input rotation, is input to the sun gear S3 via the clutch C-1. Further, the input rotation is input to the carrier CR2 by the engagement of the clutch C-2. Then, the deceleration rotation that is made higher than the forward third shift stage by the deceleration rotation input to the sun gear S3 and the input rotation input to the carrier CR2 is output to the ring gear R2, and the normal rotation as the forward fourth shift stage is output from the output gear 100.

At a forward fifth shift stage (5TH), as shown in FIG. 3, the clutch C-2 and the clutch C-3 are engaged. Then, as shown in FIGS. 2 and 4, the rotation of the carrier CR1 that is rotated at a reduced speed by the fixed sun gear S1, and the ring gear R1 that has input rotation, is input to the sun gear S2 via the clutch C-3. Further, the input rotation is input to the carrier CR2 by the engagement of the clutch C-2. Then, the acceleration rotation that is made slightly higher than the input rotation by the deceleration rotation input to the sun gear S2 and the input rotation input to the carrier CR2 is output to the ring gear R2, and the normal rotation as the forward fifth shift stage is output from the output gear 100.

At a forward sixth shift stage (6TH), as shown in FIG. 3, the clutch C-2 is engaged, and the brake B-1 is locked. Then, as shown in FIGS. 2 and 4, the input rotation is input to the carrier CR2 by the engagement of the clutch C-2. Further, the rotation of the sun gear S2 is fixed by the locking of the brake B-1. Then, the input rotation of the carrier CR2 becomes acceleration rotation that is higher than the forward fifth shift stage by the fixed sun gear S2, and is output to the ring gear R2, and the normal rotation as the forward sixth shift stage is output from the output gear 100.

At a reverse first shift stage (REV), as shown in FIG. 3, the clutch C-3 is engaged, and the brake B-2 is engaged. Then, as shown in FIGS. 2 and 4, the rotation of the carrier CR1 that is rotated at a reduced speed by the fixed sun gear S1, and the ring gear R1 that has input rotation, is input to the sun gear S2 via the clutch C-3. Further, the rotation of the carrier CR2 is fixed by the locking of the brake B-2. Then, the deceleration rotation input to the sun gear S2 is output to the ring gear R2 via the fixed carrier CR2, and the reverse rotation as the reverse first shift stage is output from the output gear 100.

In addition, for example, in the P (parking) range and the N (neutral) range, the clutch C-1, the clutch C-2, and the clutch C-3 are released. Then, the state between the carrier CR1, and the sun gear S2 and sun gear S3, i.e., between the planetary gear SP and the planetary gear unit PU is brought into a disconnected state. Further, the state between the input shaft 70 (intermediate shaft 71) and the carrier CR2 is brought into a disconnected state. This brings the power transmission between the input shaft 70 and the planetary gear unit PU into a disconnected state, that is, the power transmission between the input shaft 70 and the output gear 100 into a disconnected state.

Next, the detailed configuration of the automatic transmission 1 according to this embodiment will be explained with reference to FIG. 1.

On the X2 side of the torque converter 11, as shown in FIG. 1, a pump body 41 of an oil pump 40 to be explained later in detail is fixed so as to be integral with the transmission case 4, and is a wall portion A that becomes a wall perpendicular to the axial direction. A sleeve shaft 73 is fitted into a boss 42e formed on a pump cover 42 of the oil pump 40 so as to be integral with an inner peripheral surface of the boss 42e, and is arranged so as to be non-rotatable with respect to the transmission case 4. The input shaft 70 is rotatably supported via a bush, etc. by a hollow portion of the sleeve shaft 73. Further, the sun gear S1 of the planetary gear SP is arranged at an outer peripheral surface of the end of the sleeve shaft 73 on the X2 side by spline engagement, and is supported so as to be non-rotatable.

A flange portion 70b is formed in the portion of the input shaft 70 that is adjacent to the X2 side where the sun gear S1 is arranged, and the ring gear R1 of the planetary gear SP is connected to an outer periphery of the flange portion 70b via a connecting member. Further, at an outer peripheral surface on the X2 side of the flange portion 70b in the input shaft 70, a boss 67a of a clutch drum 67 of the aforementioned clutch C-1 is rotatably supported via a sleeve member 75.

On the other hand, a boss 65a of a clutch drum 65 of the aforementioned clutch C-3 is rotatably supported by an outer peripheral surface of the boss 42e. An inner friction plate 66 of the brake B-1 to be explained later in detail makes spline engagement with a spline 65s at an outer peripheral surface of the clutch drum 65. In addition, a center support 61 is disposed on the X2 side of the clutch C-1, and the center support 61 is fixed integrally with the transmission case 4, and supports the output gear 100 so as to be rotatable with respect to the transmission case 4. Further, the clutch drum 65 of the clutch C-3 extends to a position that becomes the X2 side of the clutch C-1 on the X2 side on the outer peripheral side of the clutch C-1, and is connected to a connecting member 68. The connecting member 68 extends toward the inner peripheral side between the clutch C-1 and the center support 61, extends toward the X2 side at the inner peripheral side of the center support 61, and is connected to the sun gear S2.

The oil pump 40 includes an oil pump gear (pump portion) 53, a pump body 41 that has a receiving hole 41b that receives the oil pump gear 53, and a pump cover 42 that blocks the receiving hole 41b. The oil pump gear 53 is configured such that a sleeve-shaped input shaft 80 connected to the aforementioned input shaft 10 is used as a driving shaft, a movable oil chamber is formed by a drive gear that rotates on the input shaft 80, and a driven gear that meshes with the drive gear, and rotates in a position that is eccentric along an the inner peripheral surface of the receiving hole 41b, and oil is sucked in the portion of a suction port, and is compressed and discharged in the portion of a discharge port.

In the pump body 41, as shown in FIG. 1, the receiving hole 41b is provided so that a hole which the input shaft 70 is arranged to pass through may become a center, an inner protruding portion 41c and an outer protruding portion 41d that have a substantially cylindrical shape are formed on the more outer peripheral side of a position where the pump cover 42 is arranged, and a cylinder portion 41a of the brake B-1 to be explained later in detail includes an annular groove formed between the inner protruding portion 41c and the outer protruding portion 41d. The cylinder portion 41a forms a working oil chamber 51 along with the piston member 31 of the brake B-1 to be explained later.

Further, within the pump body 41, as shown on the lower side in FIG. 1, an oil supply passage 46 that supplies oil to the oil pump gear 53, and similarly, an oil discharge passage 45 that discharges oil from the oil pump gear 53 are formed. Moreover, a bolt hole 41e is formed on the outer peripheral portion of the cylinder portion 41a of the pump body 41, and as the bolt 56 is screwed to the bolt hole 41e, the pump body 41 is fixed to the transmission case 4 as described above. Further, a plurality of bolt holes 41f for fixing a fixed portion 20a to be explained later and the pump cover 42 of the brake drum 20 to the pump body 41 are provided in a portion that become the inner peripheral side of the cylinder portion 41a and the outer peripheral side of the receiving hole 41b, in the pump body 41.

Further, as shown in FIG. 5, the cylinder portion 41a of the pump body 41 is formed with an opening 51b for supplying or discharging the working oil of the brake B-1 to/from the working oil chamber 51, that is, the opening 51b is connected to the hydraulic controller via an oil passage that is not shown. In addition, the cylinder portion 41a is formed with an opening 51a other than the opening 51b. The opening 51a is used to measure the oil pressure of the working oil chamber 51 at the time of a completion test, and is blocked by a plug at the time of vehicle mounting.

On the other hand, as shown in FIG. 1, the pump cover 42 has a hollow disc portion 42h that is formed in the shape of a hollow disc, and a boss 42e that extends integrally in the X2 direction from an inner peripheral portion of the hollow disc portion 42h. The boss 42e is formed in a substantially cylindrical shape, and a hollow portion of the boss is provided with a hole 42a that is formed to pass therethrough from an inner peripheral portion of the hollow disc portion 42h. A sleeve shaft 73 is arranged in the hole 42a, and the input shaft 70 is arranged to pass through a hollow portion of the sleeve shaft 73 so as to be rotatable. In addition, as described above, the clutch drum 65 of the clutch C-3 is rotatably supported by the outer peripheral surface of the boss 42e.

The hollow disc portion 42h is disposed so as to block the receiving hole 41b of the pump body 41, and by being attached to the pump body 41, a recess 47 (refer to FIG. 1) that forms an oil passage communicating with the oil pump gear 53 is formed. Further, as shown in FIG. 5, the hollow disc portion 42h has a plurality of oil through-holes 48a, 48b, 48c, 48d, and 48e that are radially bored toward the hole 42a from the outer peripheral surface 42c of the hollow disc portion 42h. Oil holes 49a, 49b, 49c, 49d, and 49e are axially bored in the plurality of oil through-holes 48a, 48b, 48c, 48d, and 48e toward the pump body 41 in positions on the outer peripheral side of the receiving hole 41b and on the inner peripheral side of the protruding portion 41c in the pump body 41. Openings (not shown) of a plurality of oil passages connected to the hydraulic controller (not shown) and the like are formed in positions corresponding to the oil holes 49a, 49b, 49c, 49d, and 49e in the pump body 41. That is, the hydraulic controller, and oil passages that are connected with the oil passage 70a formed in the input shaft 70, the oil passage 73a formed in the sleeve shaft 73, and clutches, brakes, etc., are configured so as to communicate with each other.

Further, a plurality of bolt holes 42d are provided in the positions of the hollow disc portion 42h corresponding to the bolt holes 41f of the pump body 41. In addition, outer peripheral portions of the oil holes 49a, 49b, 49c, 49d, and 49e in the oil through-holes 48a, 48b, 48c, 48d, and 48e are blocked by a plug (not shown) from the opening on the side of the outer peripheral surface 42c of the hollow disc portion 42h, and when the pump cover 42 and the pump body 41 are assembled together, slip-out of the plug is prevented by an inner protruding portion 41c that forms the cylinder portion 41a.

As shown in FIG. 1, the brake B-1 is arranged on the outer peripheral side of the planetary gear SP of the aforementioned transmission mechanism 2, and includes a brake drum (drum member) 20 that is fixed so as to be non-rotatable with respect to the transmission case 4, and a hydraulic servo 30 that is arranged adjacent to the brake drum 20.

The hydraulic servo 30 includes the cylinder portion 41a, a piston member 31, the working oil chamber 51, a return spring 33, and a receiving surface (pressure-receiving portion) 20e of the brake drum 20 (to be explained in detail) for receiving the reaction force of the return spring 33. The piston member 31 includes a base end 31b, a pressing portion 31a, and an engaging portion 31c. The base end 31b is arranged to face the cylinder portion 41a formed in the pump body 41, and is arranged so as to be slidable in the X1-X2 direction with respect to the cylinder portion 41a. Further, seal rings 54 and 55 are arranged between the base end 31b and the cylinder portion 41a, and sealing is made by the seal rings 54 and 55, thereby forming the working oil chamber 51.

The pressing portion 31a is formed so as to have a comb-toothed shape on a circumference along the peripheral direction of the piston member 31, and is adapted to pass through through-holes 20d of the brake drum 20 to be explained later so as to press outer friction plates 22.

The return spring 33 is composed of a coiled spring. A plurality of the return springs are provided in a compressed manner in peripheral equidistant positions between a connecting portion 20b of the brake drum 20 to be explained later and the piston member 31, and is adapted to receive the reaction force of the brake drum 20, and bias the piston member 31 toward the cylinder portion 41a. Further, the end of the return spring 33 in the X2 direction is fixed to a washer 32, and the washer 32 to which the return spring 33 is attached is engaged with (seated on) the receiving surface 20e of the connecting portion 20b. Furthermore, the end of the return spring 33 in the X1 direction is engaged with (seated on) the engaging portion 31c of the aforementioned piston member 31.

The brake drum 20 includes the fixed portion 20a, a connecting portion 20b, and a drum portion 20c. A plurality of bolt holes 20f are provided in positions corresponding to the bolt holes 41f of the pump body 41 and the bolt holes 42d of the pump cover 42, in inner peripheral portions of the fixed portion 20a. The bolt holes 41f, the bolt holes 42d, and the bolt holes 20f are arranged so as to overlap each other as seen the axial direction, and the pump body 41, the pump cover 42, and the brake drum 20 are simultaneously fixed with a plurality of bolts 52 (fastening members). Thereby, the brake drum 20 is fixed to the pump body 41 in which the cylinder portion 41a is formed, that is, the brake drum 20 and the cylinder portion 41a are fixed to the same wall portion A.

The connecting portion 20b is disposed on the outer peripheral side of the fixed portion 20a, and has the receiving surface 20e that forms a surface vertical to the X1-X2 direction (axial direction). Further, a plurality of through-holes 20d are formed between the connecting portion and the drum portion 20c so as to be equidistant in the peripheral direction, and the comb-toothed pressing portion 31a are arranged so as to pass therethrough. The drum portion 20c is formed in a cylindrical shape on the outer peripheral side of the connecting portion 20b, a spline 20s is formed on an inner peripheral surface of the drum portion 20c, and a plurality of outer friction plates 22 make spline engagement with the spline 20s. The outer friction plates 22 are arranged alternately with a plurality of inner friction plates 66 that make spline engagement with the clutch drum 65 of the clutch C-3, and the outer friction plates 22 and the inner friction plates 66 make up a friction plate M of the brake B-1. Moreover, the movement of the outer friction plates 22 in the X2 direction is regulated by a snap ring 62. This sets a piston stroke that is a distance from a stand-by position where the piston member 31 is locked by the biasing force of the return spring 33 to the engagement position of the brake B-1 where the friction plate M is brought into close contact.

In addition, it is described that the receiving surface 20e of the connecting portion 20b is formed in an axially vertical flat surface with which the washer 32 attached to the return spring 33 is engaged. However, for example, like the engaging portion 31c of the piston member 31, the receiving surface may has a protruding portion so that the return spring 33 can be directly engaged.

Next, the operation of the brake B-1 will be explained. In the hydraulic servo 30 of the brake B-1, when the working oil whose oil pressure based on the operation of the oil pump 40 has been regulated by the hydraulic controller (not shown) is supplied to the working oil chamber 51, thereby generating working oil pressure, the piston member 31 is driven so as to be pressed in the X2 direction against the biasing force of the return spring 33, and the pressing portion 31a of the piston member 31 presses the aforementioned friction plate M in the X2 direction, and the brake B-1 is brought into an engagement state. Further, when the working oil pressure is discharged from the working oil chamber 51, the piston member 31 is pressed in the X1 direction by the biasing force of the return spring 33, whereby the brake B-1 is brought into a released state. That is, the friction plate M that is interposed between the sun gear S2 and the brake drum 20 is engaged or released by the operation of the hydraulic servo 30, thereby operating the locking or releasing of the sun gear S2.

The brake B-1 that is engaged or released in this way is brought into an engagement state, thereby locking the rotation of the sun gear S2, at the forward second shift stage and forward sixth shift stage as described above, and is brought into a released state at the forward first shift stage, forward third shift stage, forward fourth shift stage, forward fifth shift stage, and reverse first shift stage, thereby allowing the rotation of the sun gear S2.

Meanwhile, in the automatic transmission as shown in the above JP-A-2002-349683, in the case where the multi-disc-type brake system is provided on the transmission mechanism, the drum member is fixed to the center support (corresponding to a member shown by reference numeral 61 of FIG. 1 in this embodiment) that is a member for supporting the counter gear with respect to the transmission case. In the brake system having such a configuration, the friction plate arranged at the drum member and the piston arranged at the cylinder portion are arranged on the basis of members that are separate from each other. Therefore, there is a fear that the error of the piston stroke of the brake B-1 becomes large due to the dimension error of respective parts. Further, even when the piston stroke of the assembled brake system is measured, the friction plate arranged at the drum member and the piston arranged at the cylinder portion are assembled to the members that are separate from each other. Therefore, for example, the piston stroke should be obtained by measuring the depth from an end of the transmission case to the friction plate and the protruding length of the piston from the pump body, respectively, and calculating the results thereof. As a result, there is a fear that simplification of the measurement of the piston stroke is hindered. In addition, the measurement result of the piston stroke can be used to confirm whether or not it is within the range of a manufacture error at the time of assembling, or can be used to be input to an ECU (control unit) that is not shown, and set an initial command value of the oil pressure control of the brake B-1 on the basis of the input piston stroke.

However, in the automatic transmission 1 according to the embodiment, as described above, the brake drum 20 and the cylinder portion 41a are fixed to the same wall portion A. Thus, for example, any influence caused by the dimension error of respective parts can be reduced as compared with the case where the drum member is fixed to a wall portion that is different from a wall portion in which the cylinder portion is formed like the automatic transmission of the above JP-A-2002-349683. Accordingly, the precision of the piston stroke can be improved, the controllability of the brake B-1 can be improved, and shift shock or the like can be reduced. Further, when the piston stroke of the brake B-1 is measured, the piston stroke can be measured in a state where the friction plate and the piston are assembled to the same wall portion A, that is, the brake B-1 is completely measured, the piston stroke can be directly measured without calculation, and the measurement can be made easy.

Further, it is also conceivable that the cylinder portion of the brake B-1 is formed in the pump cover 42. However, the oil through-holes formed in the radial direction in the pump cover cannot be bored from the inner peripheral side (hole 42a) of the pump cover 42. Therefore, boring is performed toward the inner peripheral surface from the outer peripheral surface 42c of the pump cover 42. Also, since the cylinder portion cannot be arranged on the outer peripheral side of the oil through-holes, the cylinder portion is arranged parallel to the oil through-holes on the axial X2 side.

However, like this embodiment, the pump body 41 and the pump cover 42 can be separately worked and then assembled by forming the cylinder portion 41a of the brake B-1 in the pump body 41. That is, by forming the oil through-holes 48 from the outer peripheral surface 42c of the pump cover 42 and then assembling the pump body 41 and the pump cover 42, it is possible to arrange the cylinder portion 41a of the brake B-1 so as to overlap the outer peripheral side of the oil through-holes 48. Accordingly, as compared with the case where the cylinder portion is formed in the pump cover as described above, it is possible to achieve the axial compactness of the automatic transmission 1 without protruding of the cylinder portion toward the X2 side.

As described above, in the automatic transmission 1 according to this embodiment, the brake drum 20 is formed so as to be vertical to the axial direction, and the receiving surface 20e that receives the reaction force of the return spring 33 is provided. Thus, it becomes unnecessary to arrange, for example, a supporting plate for receiving the reaction force of the return spring 33, a snap ring for fixing the supporting plate, and the like, a simple configuration can be obtained, and a reduction in the number of parts, or simplification of a manufacturing process can be achieved.

Further, the brake drum 20 includes a plurality of through-holes 20d through which passes the pressing portion 31a of the piston member 31 formed in a comb-toothed shape between the drum portion 20c and the fixed portion 20a, the drum portion 20c is arranged on the outer peripheral side of the piston member 31, and the fixed portion 20a is disposed on the inner peripheral side of the piston member 31. Thus, for example, by making a portion between the drum portion of the drum member, and the fixed portion project toward the inner peripheral side, and folded back toward the outer peripheral side, the need of forming the pressure-receiving portion of the return spring can be eliminated, and a simple configuration in which working can be made easily by press working or the like can be obtained.

Moreover, the automatic transmission 1 according to this embodiment includes the oil pump 40 having the pump body 41 in which the receiving hole 41b that receives the oil pump 40 that generate oil pressure is formed, and the pump cover 42 that blocks the receiving hole 41b, and the bolts 52 that fastens the pump body 41, the pump cover 42, and the fixed portion 20a of the brake drum 20. Thus, it is possible to share bolts that fix the fixed portion 20a to the transmission case 4, and bolts that fix the pump cover 42 to the pump body 41, and it is possible to reduce the number of parts.

In addition, although the automatic transmission according to this embodiment described above has been described as an automatic transmission used for an FF-type vehicle, it may be, for example, an automatic transmission that is combined with an FR-type (front engine and rear drive) vehicle or a hybrid driving device, and can be applied to any arbitrary automatic transmissions if a multi-disc-type brake system is provided with a brake drum.

Further, in the automatic transmission according to this embodiment described above, the oil pump 40 has been described as a gear-type oil pump. However, for example, a vane pump, etc. may be used. Any arbitrary oil pumps can be applied if they include a pump body in which a receiving hole is formed, and a pump cover that blocks the receiving hole, and is a wall portion within a transmission case.

Further, in the automatic transmission according to this embodiment described above, fastening members have been described as the bolts 52. However, any arbitrary fastening members may be applied if they can fasten the fixed portion of the drum member, the pump body, and the pump cover simultaneously.

The automatic transmission according to the invention can be used for vehicles, such as passenger cars, trucks, buses, and farm machines, and is suitable for those that require the reduction in the number of parts or the simplification of the manufacturing process in an automatic transmission, and is particularly suitable for those that require the reduction in the number of parts of a brake system and the simplification of the manufacturing process in an automatic transmission used for an FF-type vehicle.

According to an exemplary aspect of the invention, it is unnecessary to arrange, for example, a supporting plate for receiving the reaction force of the return spring, a snap ring for fixing the supporting plate, or the like. As a result, a simple configuration can be obtained, and a reduction in the number of parts and simplification of a manufacturing process can be achieved.

According to an exemplary aspect of the invention, it is possible to reduce any influence caused by a dimension error and to improve the precision of the piston stroke, as compared with, for example, a case where a drum member is fixed to a wall portion that is different from a wall portion in which a cylinder portion is formed. Accordingly, the controllability of a brake system can be improved, and shift shock or the like can be reduced.

According to an exemplary aspect of the invention, for example, by making a portion between the drum portion of the drum member, and the fixed portion project toward the inner peripheral side, and folded back toward the outer peripheral side, the need of forming the pressure-receiving portion of the return spring can be eliminated, and a simple configuration in which working can be made easily by press working or the like can be obtained.

According to an exemplary aspect of the invention, it is possible to share fastening members that fix the fixed portion to the case, and fastening members that fix the pump cover to the pump body, and it is possible to reduce the number of parts.

According to an exemplary aspect of the invention, it is possible to arrange the oil through-holes and the cylinder portion so as to line up in the radial direction, that is, it is possible to arrange the oil through-holes and the cylinder portion so as to overlap each other in the axial direction. Accordingly, for example, in a case where the cylinder portion is formed in the pump cover, the cylinder portion cannot be arranged on the outer peripheral side because the oil through-holes are bored from the outer peripheral side, and the oil through-holes and the cylinder portion are arranged so as to line up in the axial direction. However, axial compactness of the automatic transmission can be achieved as compared with the case where the cylinder portion is formed in the pump cover.

What is claimed is:

1. An automatic transmission comprising:
a transmission mechanism;
a case; and
a brake system that enables a rotation of a rotating element of the transmission mechanism disposed on an axis to be fixed with respect to the case, wherein the brake system includes:
a friction plate composed of inner friction plates and outer friction plates that are arranged alternately in an axial direction;
a cylinder portion that is open toward the friction plate in the axial direction;
a piston member that slidably fits into an opening portion of the cylinder portion, thereby forming a working oil chamber, and that is pressed and driven away from the cylinder portion in the axial direction by oil pressure supplied to the working oil chamber, thereby pressing the friction plate;
a return spring that biases the piston member toward the cylinder portion in the axial direction; and
a drum member integrally provided with a drum portion that is in spline engagement with the friction plate, a pressure-receiving portion that is formed in a vertical direction to the axial direction and receives a reaction force of the return spring, and a fixed portion fixed to the case.

2. The automatic transmission according to claim 1, further comprising:
a wall portion that is formed integrally with the case and is a wall vertical to the axial direction,
wherein the cylinder portion is formed in the wall portion, and the fixed portion of the drum member is fixed to the wall portion.

3. The automatic transmission according to claim 1, wherein:
the piston member has a pressing portion that extends so that a front end of the piston member is arranged to face the friction plate, and that is formed in a comb-toothed shape,
the drum member has a plurality of through-holes, through which the pressing portion is arranged to pass, provided between the drum portion and the fixed portion of the drum member, and
the drum portion is arranged on an outer peripheral side of the piston member, and the fixed portion is arranged on an inner peripheral side of the piston member.

4. The automatic transmission according to claim 1, further comprising:
an oil pump having a pump body in which a receiving hole that receives a pump portion that generates oil pressure is formed, and a pump cover that blocks the receiving hole, and
fastening members that fasten the fixed portion of the drum member, the pump body, and the pump cover.

5. The automatic transmission according to claim 4, wherein:
a rotary shaft is arranged on an inner peripheral side of the oil pump so as to pass therethrough,
the pump cover has a hollow disc portion through which the rotary shaft is arranged to pass, and that blocks the receiving hole,
the hollow disc portion has oil through-holes that are bored in a radial direction from an outer peripheral surface to an inner peripheral surface, and that communicate oil from an outer peripheral side to an inner peripheral side, from an oil passage formed in the pump body to an oil passage formed in the rotary shaft, and
the cylinder portion is formed in the pump body on the outer peripheral side of the hollow disc portion.

6. A brake system comprising:
a friction plate composed of inner friction plates and outer friction plates that are arranged alternately in an axial direction;
a cylinder portion that is open toward the friction plate in the axial direction;
a piston member that slidably fits into an opening portion of the cylinder portion, thereby forming a working oil chamber, and that is pressed and driven away from the cylinder portion in the axial direction by oil pressure supplied to the working oil chamber, thereby pressing the friction plate;
a return spring that biases the piston member toward the cylinder portion in the axial direction; and
a drum member integrally provided with a drum portion that is in spline engagement with the friction plate, a pressure-receiving portion that is formed in a vertical direction to the axial direction and receives a reaction force of the return spring, and a fixed portion.

7. The brake system according to claim 6, wherein:
the piston member has a pressing portion that extends so that a front end of the piston member is arranged to face the friction plate, and that is formed in a comb-toothed shape,
the drum member has a plurality of through-holes, through which the pressing portion is arranged to pass, provided between the drum portion and the fixed portion of the drum member, and
the drum portion is arranged on an outer peripheral side of the piston member, and the drum portion is in spline engagement with the outer friction plates, and the fixed portion is arranged on an inner peripheral side of the piston member.

8. The brake system according to claim 6, further comprising:
an oil pump having a pump body in which a receiving hole that receives a pump portion that generates oil pressure is formed, and a pump cover that blocks the receiving hole, and
fastening members that fasten the fixed portion of the drum member, the pump body, and the pump cover.

9. The brake system according to claim 8, wherein:
a rotary shaft is arranged on an inner peripheral side of the oil pump so as to pass therethrough,
the pump cover has a hollow disc portion through which the rotary shaft is arranged to pass, and that blocks the receiving hole,
the hollow disc portion has oil through-holes that are bored in a radial direction from an outer peripheral surface to an inner peripheral surface, and that communicate oil from an outer peripheral side to an inner peripheral side, from an oil passage formed in the pump body to an oil passage formed in the rotary shaft, and
the cylinder portion is formed in the pump body on the outer peripheral side of the hollow disc portion.
